(19) United States
(12) Patent Application Publication
(10) Pub. No.: US 2014/0149316 A1
(43) Pub. Date: May 29, 2014

(54) Rating System and Method

(71) Applicant: David J. Tananbaum, New York, NY (US)

(72) Inventor: David J. Tananbaum, New York, NY (US)

(21) Appl. No.: 14/092,915

(22) Filed: Nov. 27, 2013

Related U.S. Application Data
(60) Provisional application No. 61/730,551, filed on Nov. 28, 2012.

(51) Int. Cl. G06Q 40/06

(52) U.S. Cl. CPC G06Q 40/06
USPC 705/36 R

(57) ABSTRACT

A rating method for Indexing and Rating a Defined Benefit type of Retirement Plan. The method provides a rating for the financial plan, with the rating based on the comparative average earnings value of the financial plan in relation to an equity return and/or a bond return. An algorithm computes the average earnings value in relation to the equity return or the bond return to determine the appropriate rating. The rating includes a scale of A through F, with “A” rating providing the best return, and “F” rating representing a poor return. The rating method derives the rating depending on whether the equity and bond returns are positive or negative. The rating method incorporates an annual cost of living value. The different participants include a contributor, a retired, a terminated, and an active participant. The market value of the financial plan's average earnings value can be computed.

### CROSS-REFERENCE TO RELATED APPLICATIONS

The present Utility patent application claims priority benefit of the [U.S. provisional application patent Ser. No. 61/730,551 titled “System and Method for a Qualified Retirement Plan Rating System, filed on Nov. 28, 2012 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to rating a financial plan. More particularly, the invention relates to categorizing a retirement plan with a rating.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Many current systems are not able to for evaluate yearly and average yearly (3, 5, 7, and 10 year averages) of retirement plan funding, as well as, a (retirement plan) defined benefit plans ability to pay out Earned Benefits at any snapshot date.f. In 2011, 12,833 of 32,904 Defined Benefit Plans or 39% of all Defined Benfefit Plans could not pay our all earned accrued reported benefits (according to the US Department of Labor Form 5500 records) and no system to date computes defined benefit fund classification availability for any Defined Benefit Plan and percentages of class (Example Active Participants, Retirees, etc.) available for funding needs (such as Lump Sum Payments where the actuarial equivalents are usually different than required for IRS funding). The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art shows a defined benefit pension plan, In 2011, 12,833 of 32,904 Defined Benefit Plans or 39% of all Defined Benfefit Plans could not pay out all Earned Accrued reported benefits (according to the US Department of Labor Form 5500 records) and no system to date computes Defined Benefit participant classification availability and percentages of class (Example Active Participants, Retirees, etc.) available for funding needs (such as Lump Sum Payments where the actuarial equivalents are usually different than required for IRS. Fig Pay-1 illustrates clearly funds available in the current and prior years to pay benefits for a Retirement Defined Benefit Plan. The renamed “Pension Inspector® Pay All Accrued Benefit” system clearly illustrates percentages and funds available for all plan participant classes, at snapshot date, and rates the defined benefit plan upon the funds ability to pay benefits to active plan participants. The enclosed Rating and System Method is a Plan level diagnostic index and rating system.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flowchart diagram of an exemplary rating method, in accordance with an embodiment of the present invention;

FIG. 2 illustrates a flowchart diagram of an exemplary participant rating method, in accordance with an embodiment of the present invention;

FIGS. 3A, 3B, 3C, 3D, and 3E illustrate a Plan Level Indexing and Rating system fin accordance with an embodiment of the present invention;

FIG. 4 illustrates a block diagram depicting an exemplary client/server system which may be used by an exemplary web-enabled/networked embodiment of the present invention; and

FIG. 5 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of systems and methods for analyzing and rating future returns for a financial plan that may be provided by preferred embodiments of the present invention. The rating system and method may provide the algorithms and tools to instantly rate and categorize, as an initial gateway test, the financial condition of the financial plan. The financial plan may include, without limitation, a qualified or non qualified retirement plan, such as, but not limited to a funded retirement plan that meets the standards of the Employment Retirement Income Security Act (ERISA). However in other embodiments, the financial plan may include, without limitation, business ventures, investment plans, and savings plans.

In one embodiment of the present invention, the rating system and method may derive and rate future returns for a retirement financial plan. The rating system and method may provide a rating for the financial plan, with the rating based on the comparative average earnings value of the financial plan in relation to an equity return and/or a bond return. An algorithm computes the average earnings value in relation to the equity return or the bond return to determine the appropriate rating. The rating includes a scale of A+ through F, with “A+” rating providing the best return, and “F” rating representing a poor return. The rating system and method derives the rating depending on whether the equity and bond returns are positive or negative. The rating system and method incorporates an annual cost of living value. Further, the rating system and method may incorporate an annual cost of living value in the calculations for rating the financial plan. Some of these embodiments may also recognize average market performance. The different participants include a contributor, a retired, a terminated, and an active participant. The market value of the financial plan's average earnings value can be computed.

The present invention rates a financial plan to determine the plan's basic viability. The rating system and method may utilize a software application to provide a rating for a retirement financial plan, with the rating based on the performance of an equity return and/or a bond return. At least one algorithm may at least partially incorporate an average earnings value of the financial plan to determine the appropriate rating. The rating may include a scale of A+ through F, with an “A+” rating representing the best return, and an “F” rating representing a poor, or failing return. In this manner, the condition of the financial plan may be determined quickly through the rating, and appropriate actions may be taken by different participants. In addition, 3, 6, 7 and 10 year averages are represented for all testing models.

In some other embodiments, the rating system and method may compare the financial plan with at least one equity return and/or at least one bond return to ascertain the performance, and thereby the rating of the financial plan in relation to the other returns. In one embodiment, the at least one equity return may include an average of 5 major stock indices. The at least one bond return may include, without limitation, the average US Treasury 10-year Bond Performance for the period tested. The comparison of the financial plan in relation to each return is determinative of the rating. Different criteria may be used to derive the final rating. For example, without limitation, if the return for the average financial plan earned 3.5% and the 5 average stock indexes earned 30%, and the average US 10-year Treasury Rate earned 3%. The rating for that period would be a “D” rating because the average earnings value of the financial plan earned above the US 10-year Treasury return rate. However, if the average earnings value of the financial plan also earned below the US 10-year US Treasury return rate, then the rating would be an “F”. It is determined, for this testing methodology, that the average US 10 Year Treasury Bond Rate embodies a Cost of Living component plus a minimum interest earning component for the use of the Plans funds as the funds are accumulated to pay out benefits in the future.

The method may help ascertain the capacity of the financial plan to meet financial obligations based upon at least one category of user. The at least one category of user may include, without limitation, Employee Contributions, Retirees, Terminated Participants, and Active Participants. Those skilled in the art, in light of the present teachings, will recognize that the system and method may be utilized by a plurality of users having an interest in the financial plan. In this manner, the feasibility and financial integrity of the financial plan may be ascertained. The at least one user may include, without limitation, an employee contributor who may determine the safety of the financial plan. Through the use of the rating system, the contributor may better coordinate the allocation of employer contributions, selection of financial advisors, restatement of current plan provisions, and defining a qualified retirement plan objective.

Another user may include a retiree who may ascertain the Funded Percentage of Assets allocated to the retiree's class for payments being received. Another user may include a terminee. The terminee may ascertain the Funded Percentage of Assets allocated to the terminee's class for payments to be received. Another user may include an active participant, or new hire who may ascertain how well the class of benefits are funded. Additionally, an attorneys and CPA may better understand the financial plan, reducing a client's risk of regulatory problems, and to advise the client of deficiencies and positive results of the plan's current management policies. Another participant may include a consultant who may better communicate the results to participants of the financial plan for advising changes in the financial plans provisions. Another participant may include a financial plan representative who may review, and if appropriate, propose solutions to underperforming financial plans.

Some embodiments of the present invention may provide means and/or methods for performing analysis and returning a rating for a financial plan. In a non-limiting example, an embodiment system may determine a funding status with ratings of any qualified benefit plan which may be contained in a Department of Labor Form 5500 database for qualified retirement plans. In another non-limiting example, an embodiment system may ascertain an investment performance rating of any qualified retirement plan contained within a Department of Labor Form 5500 database. Many embodiments of the present invention may focus on analysis of retirement plans. However, some alternative embodiments may be suitable for a variety of financial plans, including, without limitation, business ventures, savings plans, etc.

Many embodiments may provide a means for evaluating benefit plans. Many of these embodiments may allow users to ascertain a fund's ability to pay various categories of a financial plan. Some embodiments may utilize an index and/or a rating system. In some embodiments, an embodiment system may base an evaluation on a priority allocation of various categories, including, without limitation, employee contributions, retirees, terminated participants, and active participants.

Some embodiments may be suitable for use in plan evaluations by various types of users. In a non-limiting example, an employee contributor to a financial plan may use an embodiment system to ascertain safety of a contribution. In another non-limiting example, a plan retiree may use an embodiment system to ascertain a funded percentage of assets which may be allocated to plan retiree's class for payments received. In yet another non-limiting example, a plan terminee may use an embodiment system to ascertain a funded percentage of assets which may be allocated to plan terminee's class for payments to be received. In another non-limiting example, an active and/or prospective employee may use an embodiment system to ascertain how well employees' benefits may be funded.

In some embodiments, the rating system and method may provide means for evaluating retirement plans. Many of these embodiments may provide ability to measure fund investment performance. Some embodiments may utilize stock indices. In a non-limiting example, an embodiment system may utilize an average of five major stock indices. Some embodiments may default and/or prevent failing grades to average US Treasury 10-year bond performance for a period tested. Many embodiments may be suitable for use by a variety of users, including, without limitation, plan participants, plan sponsors, and prospective hires as a means of reviewing results. In a non-limiting example, if a period showed an average fund earning was 3.5%, an average stock index earned 30%, and an average US 10-year Treasury rate was 3%, the period may receive a “D” rating to signify below-average performance while above US Treasury rate. Some of these embodiments may be suitable for use by various types of users.

In a non-limiting example, a plan sponsor may use embodiment system to better coordinate, allocate employer contributions, select financial advisors, provide restatements of plan provisions, and management plan objectives. In another non-limiting example, attorneys and/or CPAs may use an embodiment system to develop understanding, reduce client risk of regulatory problems, and advise clients of deficiencies and/or positive results of a plan's management policies. In yet another non-limiting example, a plan consultant may use an embodiment system to better communicate results to participants and/or advise of changes in a plan's provisions. In another non-limiting example, benefit product representatives may use an embodiment system to review and/or, if appropriate, propose solutions to underperforming plans.

In at least one embodiment, a rating system may rate a plan's ability to fund all or some benefits at a plan snapshot date. In some embodiments, a performance rating system may provide a rating system which may recognize various changing costs, including, without limitation, cost of living increase. Some of these embodiments may also recognize average market performance.

In one or more embodiments, assets attributable to Active Participants of Defined Benefit Retirment Plans may be isolated after subtracting direct liability and/or assets of terminated and/or retired participants.

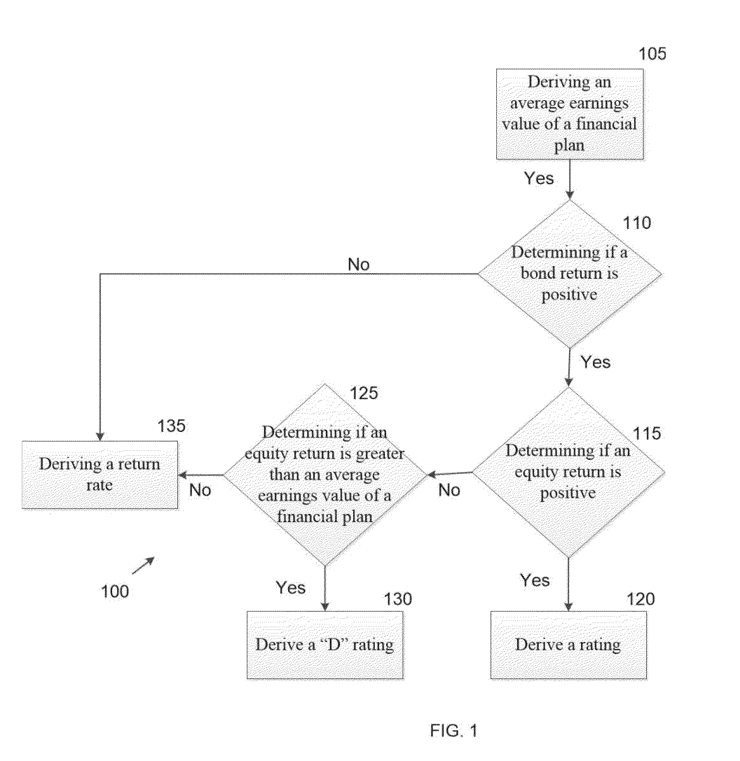

FIG. 1 illustrates a flowchart diagram of an exemplary rating method, in accordance with an embodiment of the present invention. In the present invention, the rating method may determine an average earned present value for a given time period in a Step 105. Some embodiments may utilize a variety of algorithms for determining an average earnings ratio.

The Average Earned Income of a Plan for any determination period may be determined by utilizing at least one algorithm. In a non-limiting example, the at least one algorithm may be as follows: (2*Retirment Plan Plan Net Incomefor the Plan Year testing period)/(Retirment Plan Net Assets @ Market Value Opening Balance+Plan Net Assets @ Market ValueEnding Balance−Retirement Plan's Net Income for the testing period). In the present non-limiting example, Net Income may equal Fund Earnings minus Fund Administration Expenses. By using the above formula, as a substitute, but not excluding, when available actual dates and amounts of plan receipts and disbursements combined with the 10 year US Treasury aveage rate a default minimum earnings regimen is developed accounting for Cost of Living and minimum usage of money earnings for comparison against other plans within the group tested. In addition, the Average Direct Expense Percentage is computed by substituting Direct Expenses of the Plan for the Plan Year tested for Net Income for Net Income of the Plan Year in the above formula.

In the present renamed “Retirement Plan Funding Index and Rating System embodiment, a Step 110 may include determining if a bond return is positive. The bond return may include an average 10-year US Treasury bond rate. Further, in the present embodiment, if an average 10-year US Treasury bond rate is positive, the rating method may then proceed to a Step 115 of determining if an equity return is positive. The equity return may include an average of one or more stock equity indices, including, without limitation, Dow Jones Industrial Average, American Exchange, Standard and Poor's 500, Russel 2000, and New York Stock Exchange. A recap of the rules for this embodiment is as follows: Description Of Testing Method For each Plan Year where both the Average 10 Year U.S. Treasury Bond Rate and the Average of the 5 Stock Growth Indices are Positive—The Plan Reported Average Investment Earning Rate is divided by the greater of the Average 10 Year U.S. Treasury Bond Interest Rate, or, the average of the 5 major Stock Indices (as listed below) subject to grading rate as listed above.
1. Special Rule for Plan Years where the 5 Average Stock Indic is Negative—even though the Average 10 Year Bond Yield Average is positive—If the Negative Average Plan Investment rate of return is less than the Average 5 Indices Negative rate—the Pension Inspector Risk-Free-Market Investment Performance Rating for that year shall be D.
2. If the yearly Stock Indic is positive (+) and greater than the 10 year US Treasury Average Rate THE MINIMUM RATING IS AN “D” FOR THAT YEAR. All Pension Inspector Risk-Free-market Investment Ratings are subject to available data and proprietary data filtering techniques.
3. Multi Year Average Rating (3, 5, 7, and 10 year) profiles the methodology of single year indexing and rating except indexing for any one year of any average is limited to 120%. If years are missing for any average, the nearest available (lower) year data is utilized. If for any Average Rating a Rating of “F” is computed for any year, for the computation of the above averages, an index of 30 shall be computed for each year.
4. In 2011 45,862 of 591,069 or 7.759% of plans earned less that the Average US 10 Year Treasury Rate of 3.25%. However, the 45,862 Plans that did not earn greater than the 10 Year US Treasury Rate of 3.25% impacted 9,912,555 workers in all types of Qualified Plans (not counting Federal, State, and Local retirement Plans).

In the present embodiment, if the bond return and the equity return are both positive for a predetermined duration, the rating method may derive the rating in a Step 120. In one embodiments, at least one algorithm may be used to derive the rating. The at least one algorithm may include, without limitation, the following: (Average Earned Present Value)/(Average of Equity Indices); or (Average Earned Present Value)/(Average of US 10 Year Treasury Bond).

However, if the bond return is negative, a return rate for the financial plan may be derived in a Step 135. In some of these embodiments, the return rate may be converted into the rating through a process of categorizing the return rate into a predetermined rating category. Further, in some of these embodiments, the return rate may be translated to a percentage value.

In a non-limiting example, the return rate may be translated to the rating as follows: a return rate ratio of 1.01-1.10 may result in an “A” rating; a return rate ratio of 0.81 to 1 may result in a “B” rating; a return rate ratio of 0.51 to 0.8 may result in a “C” rating; a return rate ratio of 0.31 to 0.5 may result in a “D” rating; a return rate ratio of 0 to 0.3 may result in an “F” rating. In one embodiment, if the average of one or more stock indices is positive and greater than 10-year US Treasury average rate, the rating method may output no less than a 0.31, or “D” rating.

In another embodiment, if the equity return is positive and greater than the bond return rate, the rating comprises a “D” rating, and subject to the following rating schedule:

### A+=111%+

### A=101%-110%

### B=81% to 100%

### C=51% to 80%

### D=31% to 50%

### F=0% to 30%

In some embodiments, if the equity return is determined to be negative in Step 115, the rating method may proceed to a Step 125 of determining if an equity return is greater than a financial plan return.

In some embodiments, the combination of a negative bond return, and an equity return that is greater than the financial plan return results in a Step 130 of deriving a “D” rating. In this manner, if a negative financial plan return is less than negative average of the equity return, the rating method results in a “D” rating. For example, without limitation, if the return for the average financial return earned 3.5%, the 5 average stock indices earned 30%, and the average US 10 Year Treasury Rate earned 3%, the rating for that period would be a “D” because the financial plan return earned above the bond return, or US 10 Year Treasury Rate. However, if the financial plan return also earned below the bond return, then the rating would be an “F”.

Conversely, if the Step 125 determines that the financial plan return is greater than the equity return, the rating method proceeds to the Step 135 of deriving the return rate. The return rate may then be converted into the appropriate rating through a process of categorizing the return rate into a predetermined rating category.

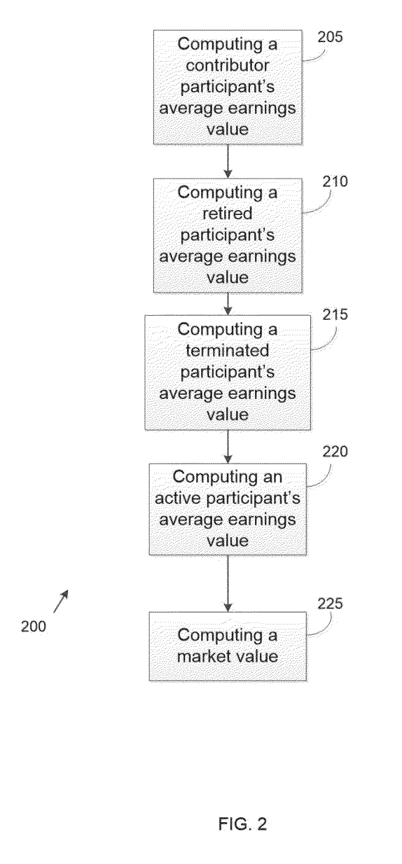

FIG. 2 illustrates a flowchart diagram of an exemplary participant rating method, in accordance with an embodiment of the present invention. In the present invention, the participant rating method 200 may help determine a status of a financial plan for a plurality of participants in the financial plan, with each participant having a different interest and function. In one or more steps, values may be subject to specific provisions of financial plan. In the present embodiment, the method may compute a participant's mandatorily and/or voluntarily contributed class of participant's average earnings value of accrued benefit.

In one embodiment, an average earnings ratio, for each year, may be compared against equity stock indices. In some of these embodiments, average earnings ratio may be limited by average per-year earnings of the bond return.

In some embodiments, a Step 205, may comprise computing a contributor participant's average earnings value. The contributor participant may select discounting assumptions which a value determination may be subject to. The method may compute each retired participant's class of participant's average earnings value in a Step 210. Further, in the present embodiment, the method may compute each terminated participant's average earnings value of accrued benefit in a Step 215. Still further, in the present embodiment, the method may compute each active participant's average earnings value of accrued benefit in a step 220. Further, in the present embodiment, the method may compute a market value of all assets of the financial plan in a step 225. In some embodiments, the method may utilize an actual market value of all assets on a given valuation date to determine market value of assets.

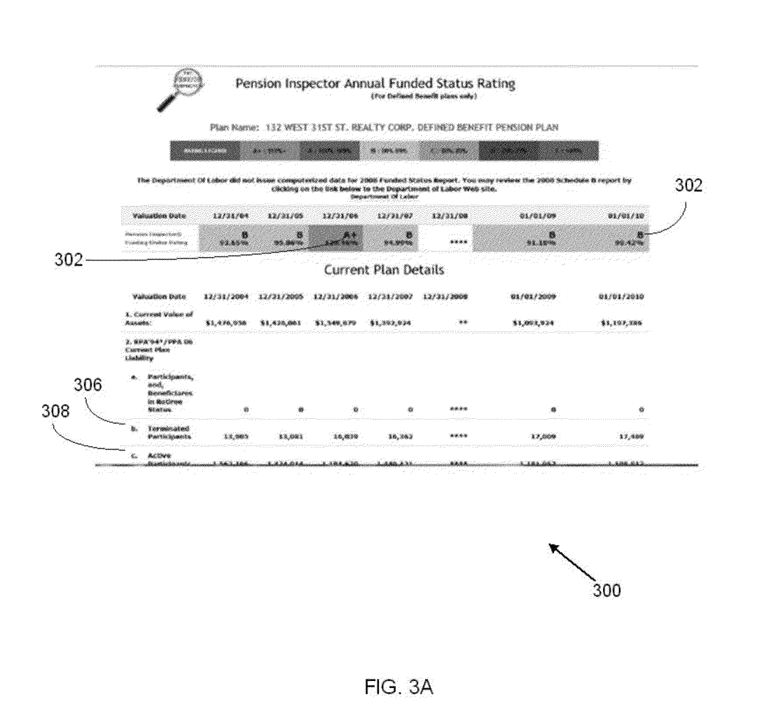

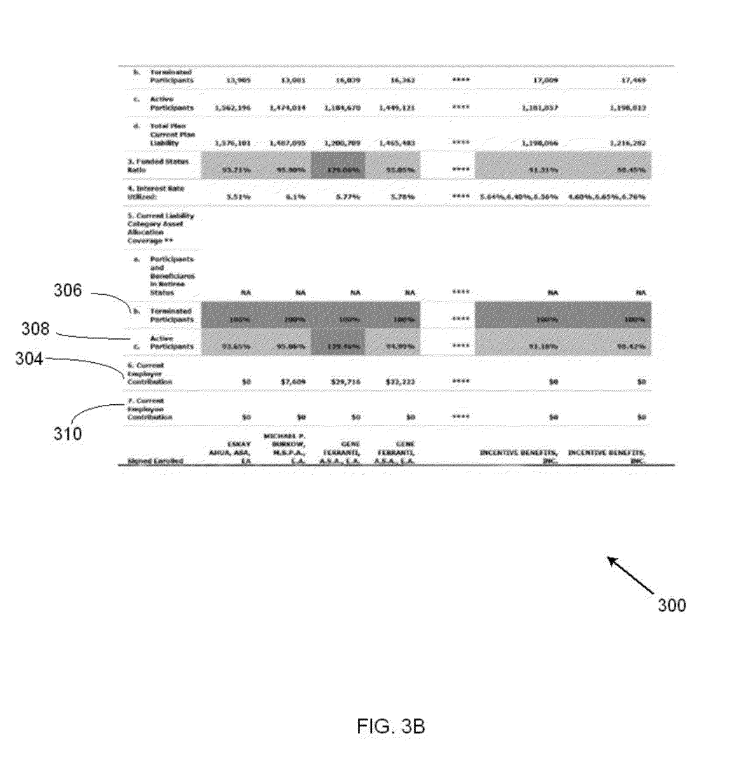

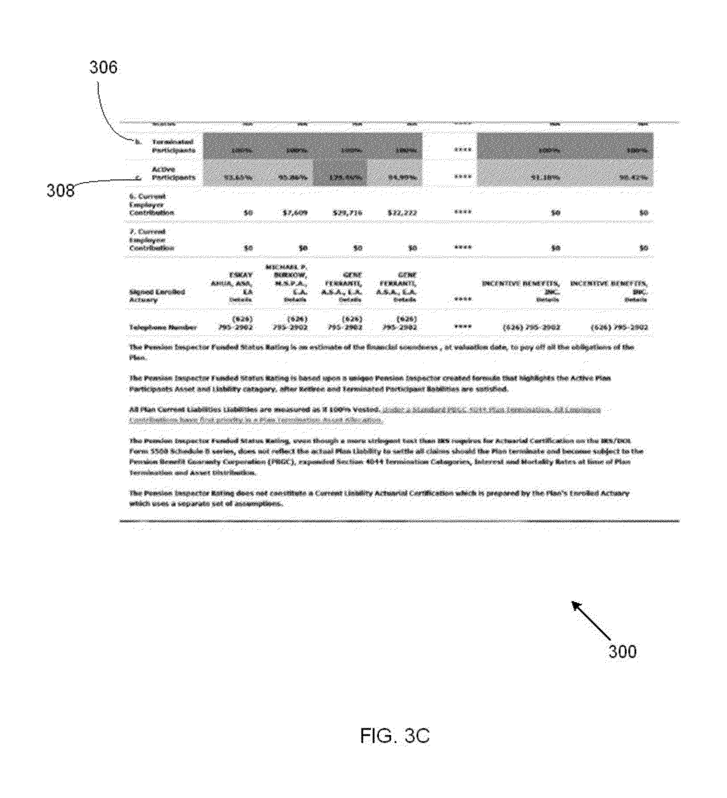

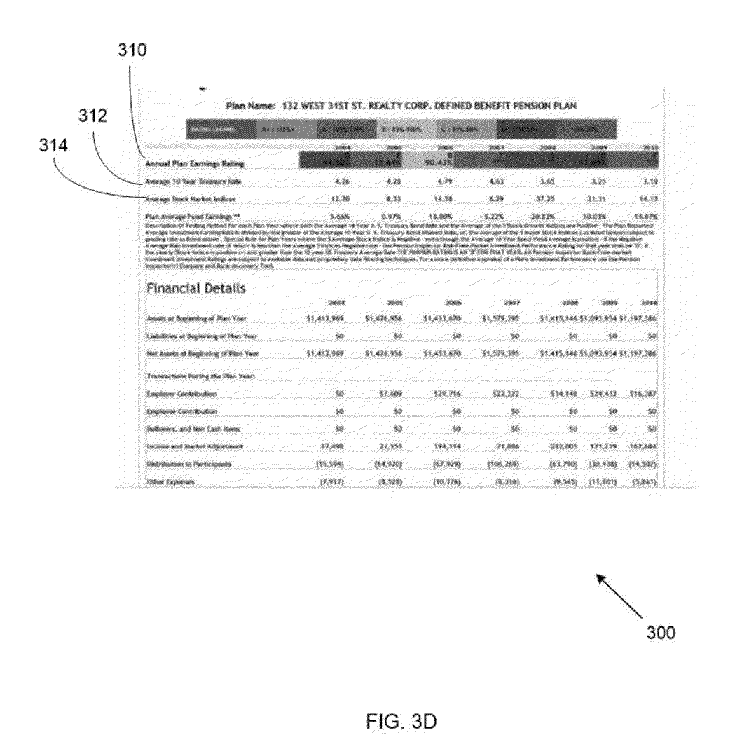

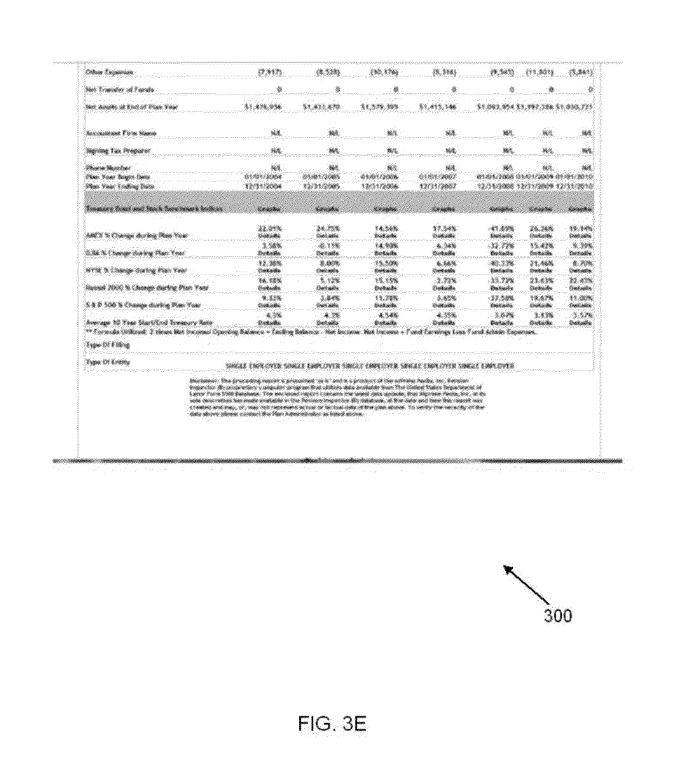

FIGS. 3A, 3B, 3C, 3D, and 3E illustrate a rating system of a financial plan, in accordance with an embodiment of the present invention. In the present invention, a rating system 300 may provide a rating 302 for the finance plan. In some of these embodiments, the system may divide a participant's average earnings value by market value of assets. The different participants may include, without limitation, a contributing participant 304, a retired participant 310, a terminated participant 306, and an active participant 308. Additionally, an attorneys and CPA may better understand the financial plan, reducing a client's risk of regulatory problems, and to advise the client of deficiencies and positive results of the plan's current management policies. Another participant may include a consultant who may better communicate the results to participants of the financial plan for advising changes in the financial plans provisions. Another participant may include a financial plan representative who may review, and if appropriate, propose solutions to underperforming financial plans. Some embodiments of the system may be suitable for use by pension inspectors.

In some embodiments, the system may work to subtract market value of assets by liability of present value of accrued benefit for a retired participant. In one example, the retired participant may have made voluntary contributions to provisions of a defined benefit plan or as part of required provisions of plan. The system may also divide results by present value benefits computed for the terminated participant. In some embodiments, the system may compute a status for the terminated participant by subtracting a market value of assets from a liability of present value of accrued benefit for a retired participant who may have made voluntary and/or mandatory contributions. The system may then divide by the present value of the terminated participant. In some of these embodiments, ratio may not exceed 1.

In some embodiments, information used in calculations may be received from various sources, including, without limitation, an employer and/or a Department of Labor Form 5500 database. In many embodiments, as more detailed information may become available, the system may perform an expansion of rating categories. Many embodiments may measure residue of assets and/or liabilities of an active participant group as a standard. Some embodiments may provide a rating system which may recognize an implied cost of living increase within an average of 10-year US Treasury rate for a given year and average market investment performance over a given period of time.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

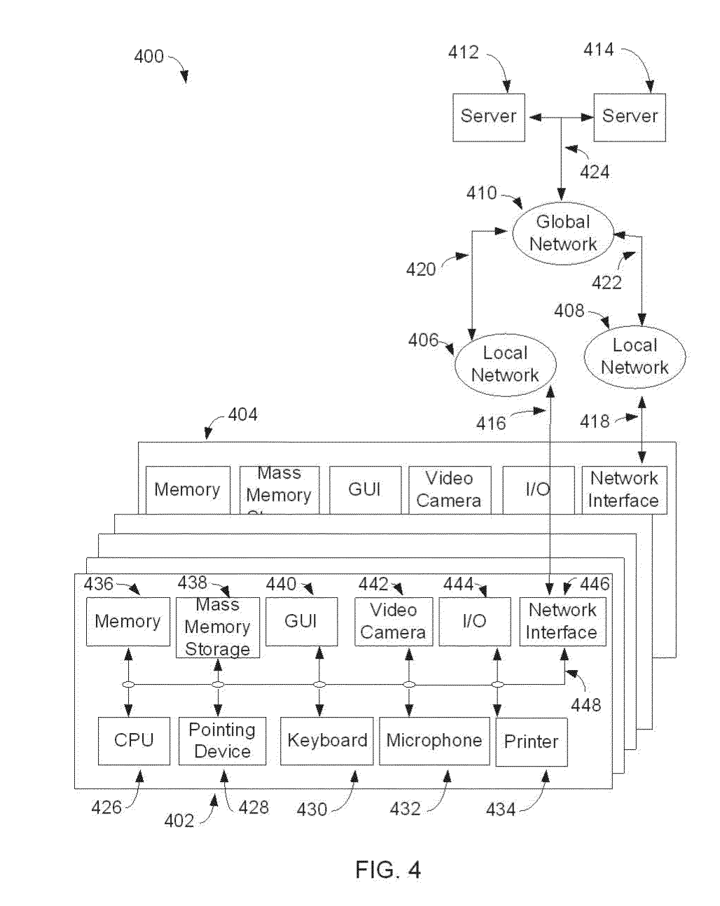

FIG. 4 illustrates a block diagram depicting an exemplary client/server system which may be used by an exemplary web-enabled/networked embodiment of the present invention.

A communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 404, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 444. Communication channel 444 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

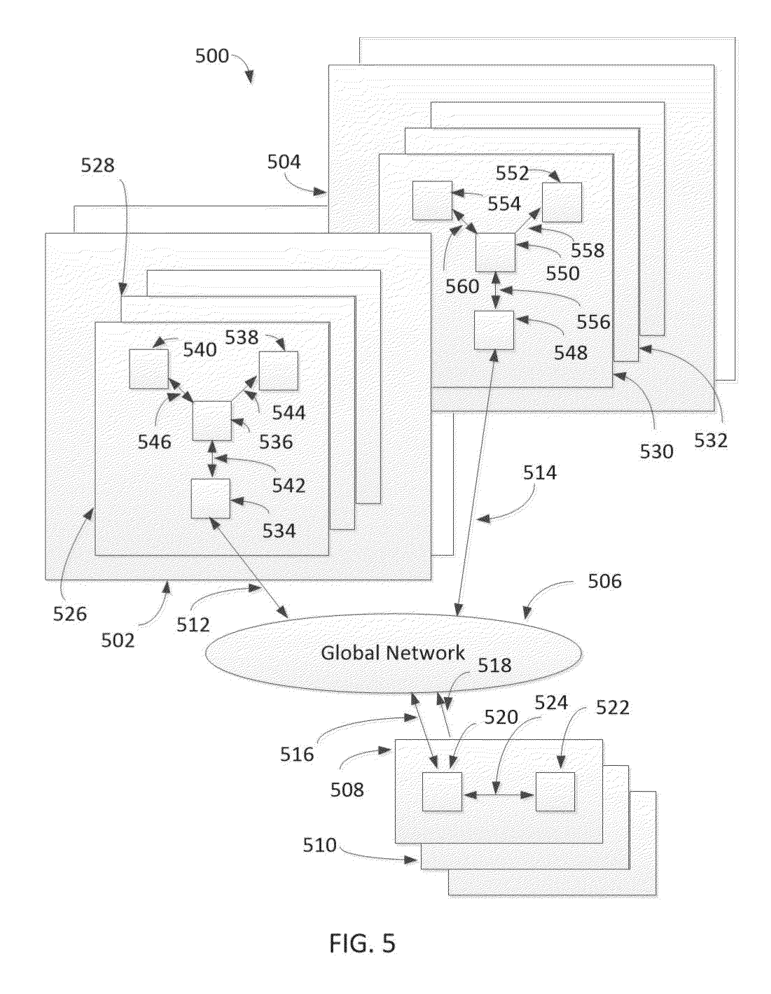

FIG. 5 illustrates a block diagram depicting a conventional client/server communication system.

A communication system 500 includes a multiplicity of networked regions with a sampling of regions denoted as a network region 502 and a network region 504, a global network 506 and a multiplicity of servers with a sampling of servers denoted as a server device 508 and a server device 510.

Network region 502 and network region 504 may operate to represent a network contained within a geographical area or region. Non-limiting examples of representations for the geographical areas for the networked regions may include postal zip codes, telephone area codes, states, counties, cities and countries. Elements within network region 502 and 504 may operate to communicate with external elements within other networked regions or within elements contained within the same network region.

In some implementations, global network 506 may operate as the Internet. It will be understood by those skilled in the art that communication system 500 may take many different forms. Non-limiting examples of forms for communication system 500 include local area networks (LANs), wide area networks (WANs), wired telephone networks, cellular telephone networks or any other network supporting data communication between respective entities via hardwired or wireless communication networks. Global network 506 may operate to transfer information between the various networked elements.

Server device 508 and server device 510 may operate to execute software instructions, store information, support database operations and communicate with other networked elements. Non-limiting examples of software and scripting languages which may be executed on server device 508 and server device 510 include C, C++, C# and Java.

Network region 502 may operate to communicate bi-directionally with global network 506 via a communication channel 512. Network region 504 may operate to communicate bi-directionally with global network 506 via a communication channel 514. Server device 508 may operate to communicate bi-directionally with global network 506 via a communication channel 516. Server device 510 may operate to communicate bi-directionally with global network 506 via a communication channel 518. Network region 502 and 504, global network 506 and server devices 508 and 510 may operate to communicate with each other and with every other networked device located within communication system 500.

Server device 508 includes a networking device 520 and a server 522. Networking device 520 may operate to communicate bi-directionally with global network 506 via communication channel 516 and with server 522 via a communication channel 524. Server 522 may operate to execute software instructions and store information.

Network region 502 includes a multiplicity of clients with a sampling denoted as a client 526 and a client 528. Client 526 includes a networking device 534, a processor 536, a GUI 538 and an interface device 540. Non-limiting examples of devices for GUI 538 include monitors, televisions, cellular telephones, smartphones and PDAs (Personal Digital Assistants). Non-limiting examples of interface device 540 include pointing device, mouse, trackball, scanner and printer. Networking device 534 may communicate bi-directionally with global network 506 via communication channel 512 and with processor 536 via a communication channel 542. GUI 538 may receive information from processor 536 via a communication channel 544 for presentation to a user for viewing. Interface device 540 may operate to send control information to processor 536 and to receive information from processor 536 via a communication channel 546. Network region 504 includes a multiplicity of clients with a sampling denoted as a client 530 and a client 532. Client 530 includes a networking device 548, a processor 550, a GUI 552 and an interface device 554. Non-limiting examples of devices for GUI 538 include monitors, televisions, cellular telephones, smartphones and PDAs (Personal Digital Assistants). Non-limiting examples of interface device 540 include pointing devices, mousse, trackballs, scanners and printers. Networking device 548 may communicate bi-directionally with global network 506 via communication channel 514 and with processor 550 via a communication channel 556. GUI 552 may receive information from processor 550 via a communication channel 558 for presentation to a user for viewing. Interface device 554 may operate to send control information to processor 550 and to receive information from processor 550 via a communication channel 560.

For example, consider the case where a user interfacing with client 526 may want to execute a networked application. A user may enter the IP (Internet Protocol) address for the networked application using interface device 540. The IP address information may be communicated to processor 536 via communication channel 546. Processor 536 may then communicate the IP address information to networking device 534 via communication channel 542. Networking device 534 may then communicate the IP address information to global network 506 via communication channel 512. Global network 506 may then communicate the IP address information to networking device 520 of server device 508 via communication channel 516. Networking device 520 may then communicate the IP address information to server 522 via communication channel 524. Server 522 may receive the IP address information and after processing the IP address information may communicate return information to networking device 520 via communication channel 524. Networking device 520 may communicate the return information to global network 506 via communication channel 516. Global network 506 may communicate the return information to networking device 534 via communication channel 512. Networking device 534 may communicate the return information to processor 536 via communication channel 542. Processor 546 may communicate the return information to GUI 538 via communication channel 544. User may then view the return information on GUI 538.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation:

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing financial plan analysis according to the present invention will be apparent to those skilled in the art. Various aspects of the invention have been described above by way of illustration, and the specific embodiments disclosed are not intended to limit the invention to the particular forms disclosed. The particular implementation of the financial plan analysis may vary depending upon the particular context or application. By way of example, and not limitation, the financial plan analysis described in the foregoing were principally directed to retirement plan implementations; however, similar techniques may instead be applied to any suitable financial plan, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. One or more computer storage media storing computer-usable instructions, that when used by one or more computing devices, cause the one or more computing devices to perform a rating method comprising the steps of:
(a) determining an average earnings value for a financial plan;
(b) determining if a bond return is positive;
(c) determining if an equity return is positive;
(d) deriving a rating;
(e) determining if said equity return is greater than said average earnings value;
(f) deriving a D rating;
(g) deriving a return rate; and,
(h) determining of an Indexing and Rating at least in part based on said rating, said Indexing and Rating being useful for a Defined Benefit type of Retirement Plan to value the various participant Priority Classifications of the plan, at snapshot date, to receive benefits.

2. The method of claim 1, in which said financial plan comprises a retirement plan, said retirement plan being operable to meet at least one standard for the Employment Retirement Income Security Act.

3. The method of claim 2, in which said bond return comprises an average return for a 10-year US treasury bond.

4. The method of claim 3, in which said equity return comprises an average return of at least one stock index, said at least one stock index comprising, Dow Jones Industrial Average, or American Exchange, or Standard and Poor's 500, or Russel 2000, or New York Stock Exchange.

5. The method of claim 4, in which said average earning value comprises at least one algorithm, said at least one algorithm comprising (2*Financial Plan Net Income)/(Opening Balance+Ending Balance−Financial Plan Net Income).

6. The method of claim 5, in which said Financial Plan Net Income is equivalent to (Financial Plan Earnings−Financial Plan Administration Expenses).

7. The method of claim 6, in which step (b) comprises deriving a return rate if said bond return is negative.

8. The method of claim 7, in which said return rate is operable to translate to said rating, said translation comprising a return rate ratio of 1.01-1.10 for an A rating, or a return rate ratio of 0.81 to 1 for a B rating, or a return rate ratio of 0.51 to 0.8 for a C rating, or a return rate ratio of 0.31 to 0.5 for a D rating, or a return rate ratio of 0 to 0.3 for an F rating.

9. The method of claim 8, in which step (c) comprises determining said equity return is positive and greater than said bond return for generating a minimum rating of said D rating.

10. The method of claim 9, in which step (d) comprises deriving said return rate if said bond return is positive and said equity return is positive.

11. The method of claim 10, in which said rating comprises an A+ rating, said A+ rating comprising an active participant asset coverage residue of at least 110%.

12. The method of claim 11, in which said rating comprises an A rating, said A rating comprising an active participant asset coverage residue of 100% to 109%.

13. The method of claim 12, in which said rating comprises a B rating, said B rating comprising an active participant asset coverage residue of 90% to 99%.

14. The method of claim 13, in which said rating comprises a C rating, said C rating comprising an active participant asset coverage residue of 80% to 89%.

15. The method of claim 14, in which said rating comprises a D rating, said D rating comprising an active participant asset coverage residue of 70% to 79%.

16. The method of claim 15, in which said rating comprises an F rating, said F rating comprising an active participant asset coverage residue of 69% or less.

17. The method of claim 16, in which step (e) comprises deriving said return rate if said average earnings value is greater than said equity return.

18. The method of claim 17, in which step (e) comprises deriving said D rating if said equity return is greater than said average earnings value.

19. A system for rating, said system comprising:
means for determining an average earnings value for a financial plan, said financial plan comprising a retirement plan;
means for determining if a bond return is positive, said bond return comprising an average return for a 10-year US treasury bond.
means for determining if an equity return is positive said equity return comprising an average return of at least one stock index, said at least one stock index comprising, Dow Jones Industrial Average, or American Exchange, or Standard and Poor's 500, or Russel 2000, or New York Stock Exchange.
means for deriving a rating;
means for determining if said equity return is greater than said average earnings value;
means for deriving a D rating; and
means for deriving a return rate, said return rate being operable to translate to said rating, said translation comprising a return rate ratio of 1.01-1.10 for an A rating, or a return rate ratio of 0.81 to 1 for a B rating, or a return rate ratio of 0.51 to 0.8 for a C rating, or a return rate ratio of 0.31 to 0.5 for a D rating, or a return rate ratio of 0 to 0.3 for an F rating.

20. One or more computer storage media storing computer-usable instructions, that when used by one or more computing devices, cause the one or more computing devices to perform a participant rating method comprising the steps of:
(a) computing a contributor participant's average earning value;
(b) computing a retired participant's average earning value;
(c) computing a terminated participant's average earning value;
(d) computing an active participant's average earning value;
(e) computing an Indexing and Rating at least in part based on said rating, said Indexing and Rating being useful for a Defined Benefit type of Retirement Plan to value the various participant Priority Classifications of the plan, at snapshot date, to receive benefits; and,
(f) computing a market value.
